(19) United States
(12) Patent Application Publication
(10) Pub. No.: US 2017/0036534 A1
(43) Pub. Date: Feb. 9, 2017

(54) Filler Neck for a Vehicle with Improved Diffusion Resistance

(71) Applicant: MAGNA STEYR Fuel Systems GesmbH, Sinabelkirchen (AT)

(72) Inventors: René HENDLER, Graz (AT); Michael BINDER, Gleisdorf (AT)

(21) Appl. No.: 15/231,129

(22) Filed: Aug. 8, 2016

(30) Foreign Application Priority Data
Aug. 7, 2015 (EP) 15180185.9

(51) Int. Cl. B60K 15/04

(52) U.S. Cl. CPC B60K 15/04; B60K 2015/0477

(57) ABSTRACT

A tank filler neck for a motor vehicle including a tube having an outer tube portion and an inner tube portion, a barrier layer embedded between the outer tube portion and an inner tube portion, the barrier layer having a thickness at a first region thereof that is greater than a thickness than remaining regions thereof, and a seal arranged to directly contact the barrier layer at the first region. In that way, the barrier layer is to inhibit diffusion of hydrocarbons through the tube at a first region more than the remaining portion(s) the plastic tube.

### CROSS-REFERENCE TO RELATED APPLICATIONS

The present application claims priority under 35 U.S.C. §119 to European Patent Publication No. EP 15180185.9 (filed on Aug. 7, 2015), which is hereby incorporated by reference in its entirety.

### TECHNICAL FIELD

Embodiments relate to a tank filler neck for a motor vehicle, and motor vehicle having a tank filler neck. The filler neck comprises a plastic tube having a tubular barrier layer which inhibits diffusion of hydrocarbons at a level greater than the rest of the plastic tube, a filler head composed of metal surrounding the plastic tube at the end thereof, and a seal composed of an elastomer arranged between the plastic tube and the filler head.

### BACKGROUND

In principle, a filler neck of this kind and a motor vehicle of this kind are known from the prior art. In this connection, German Patent Publication No. DE 199 43 673 A1, for example, discloses an insert composed of a thermoplastic material for connection to a fuel tank. The insert is obtained by press forming a laminate of high impermeability to hydrocarbons.

Furthermore, German Patent Publication No. DE 10 2005 050 564 A1 discloses a filler neck having a seal, which is connected to a plastic tank produced from synthetic resin. The plastic tank is composed of high density polyethylene with a layer of ethylene vinyl alcohol copolymer (EVOH) embedded therein.

FIG. 1 illustrates a tank filler neck 1 according to the prior art. The tank filler neck 1 comprises a plastic tube 2 having a tubular barrier layer 3, a filler head 4 surrounding the plastic tube 2 at the end thereof, and a seal 5 arranged between the plastic tube 2 and the filler head 4.

FIG. 2 illustrates a detail A of the tank filler neck 1 illustrated in FIG. 1. It is readily visible that there is a path B which bypasses the barrier layer 3 and the seal 5 and via which hydrocarbons can diffuse outwards from the interior of the tank filler neck

In the known designs, there is a path which bypasses a barrier layer and a seal and via which hydrocarbons can diffuse outwards from the interior of the tank or the interior of the tank filler neck in an unwanted manner. Particularly in respect of increased legal requirements as regards hydrocarbon emissions in fuel tank systems, it is not possible to guarantee sufficiently good leaktightness of the system in this way, especially over the entire life of a motor vehicle.

### SUMMARY

Embodiments relate to an improved tank filler neck and an improved motor vehicle, which reduce emissions of hydrocarbons from the fuel tank system as compared with the prior art.

In accordance with embodiments, a tank filler neck includes a plastic tube having a tubular barrier layer which inhibits diffusion of hydrocarbons at a level greater than the rest of the plastic tube, a filler head composed of metal surrounding the plastic tube at the end thereof, and a seal composed of an elastomer arranged between the plastic tube and the filler head, the seal arranged to contact the barrier layer.

In accordance with embodiments, a tank filler neck for a motor vehicle, comprises: a tube having a barrier layer which inhibits diffusion of hydrocarbons through the tube at a first region thereof greater than in remaining regions thereof; a filler head surrounding the tube at an end thereof; and a seal composed of an elastomer arranged between the plastic tube and the filler head, and which directly contacts the barrier layer.

In accordance with embodiments, a tank filler neck for a motor vehicle, comprises: a tube having an outer tube portion and an inner tube portion; a barrier layer embedded between the outer tube portion and an inner tube portion, the barrier layer having a thickness at a first region thereof that is greater than a thickness than remaining regions thereof; and a seal arranged to directly contact the barrier layer at the first region.

In accordance with embodiments, a motor vehicle, comprises: a tank filler neck including: a tube having an outer tube portion and an inner tube portion; a barrier layer embedded between the outer tube portion and an inner tube portion, the barrier layer having a thickness at a first region thereof that is greater than a thickness than remaining regions thereof; and a seal arranged to directly contact the barrier layer at the first region.

In accordance with embodiments, a motor vehicle includes a tank filler neck having a plastic tube having a tubular barrier layer which inhibits diffusion of hydrocarbons at a level greater than the rest of the plastic tube, a filler head composed of metal surrounding the plastic tube at the end thereof, and a seal composed of an elastomer arranged between the plastic tube and the filler head, the seal arranged to contact the barrier layer.

In accordance with embodiments, a closed barrier for hydrocarbons can be set up, thereby significantly improving the sealing of the tank filler neck, and enabling hydrocarbon emissions to be reduced accordingly. In particular, the seal can be produced from a rubber and/or can be designed as an O-ring.

In accordance with embodiments, a “barrier layer” does not mean that diffusion must necessarily be 100% prevented. The barrier layer, however, does at least inhibit diffusion, i.e., the permeability of the barrier layer is lower than the permeability of the rest of the tube. In other words, the barrier layer is less open to diffusion than the remaining portion(s) of the plastic tube, or the barrier layer is more leaktight in respect of the diffusion of hydrocarbons than the remaining portion(s) of the plastic tube. In particular, provision can be made for the barrier layer to prevent diffusion of hydrocarbons by at least 95%.

Embodiments recognize that, in solutions known from the prior art, there is a path which bypasses a barrier layer and a seal and via which hydrocarbons can diffuse outwards from the interior of the tank or the interior of the tank filler neck in an unwanted manner.

Further advantageous embodiments will become apparent from the dependent claims and from the description when considered together with the figures.

In accordance with embodiments, it is particularly advantageous if the barrier layer is made having a thickness that is greater in the region of the seal than in the remaining portion(s) of the plastic tube. In this way, tolerances with respect to the position of the barrier layer can be compensated more effectively. Alternatively, the barrier layer can have a thickness that is relatively thin in the remaining portion(s) of the tube.

In accordance with embodiments, it is also advantageous if the barrier layer is embedded into the plastic tube. When seen in cross-section, the barrier layer can then be seen as circular, the diameter of which is greater than an inside diameter of the tube, and less than an outside diameter of the tube. Consequently, the relatively thin and sensitive barrier layer can be well protected against damage.

In accordance with embodiments, it is furthermore advantageous if the barrier layer is composed of ethylene vinyl alcohol copolymer (EVOH). In this way, diffusion of the hydrocarbons can be prevented or inhibited particularly effectively.

In accordance with embodiments, it is also advantageous if the seal is arranged radially to the outside of the barrier layer. In this way, a surface pressure required for the sealing effect can be achieved by choosing appropriate diameters for the plastic tube and the filler head in the region of the seal. To be specific, the gap between the inner and outer contact surfaces of the seal is chosen to be less than the thickness of the seal.

In accordance with embodiments, it is also advantageous if the seal is arranged axially to the outside of the barrier layer. In this way, a sealing surface can be produced, in particular, by sawing/cutting to length, face milling or face grinding the plastic tube.

In accordance with embodiments, it is particularly advantageous if the seal is arranged in a groove, and a groove base is formed at least partially by the barrier layer. A coupling between the barrier layer and the seal can thereby be produced in a particularly simple way, e.g., by milling or sawing the plastic tube down to the barrier layer. In particular, it would also be conceivable to produce the groove directly during the extrusion of the plastic tube, e.g., by briefly switching off an extruder for a layer lying outside the barrier layer.

### DRAWINGS

Embodiments will be illustrated by way of example in the drawings and explained in the description below.

FIG. 1 illustrates a related art tank filler neck.

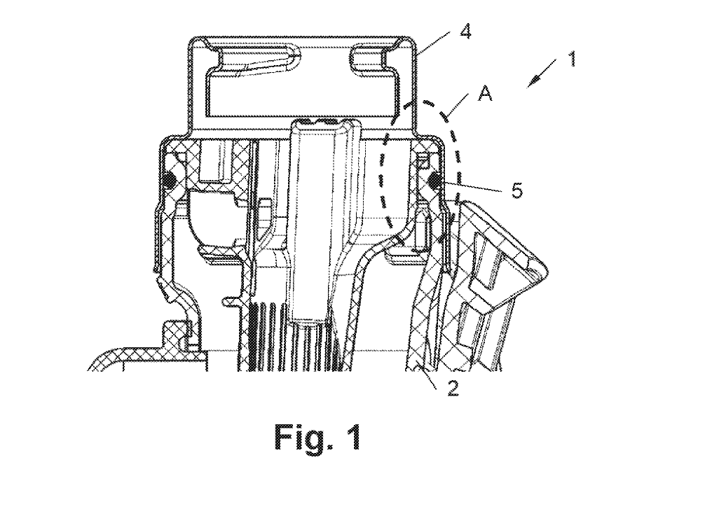

FIG. 2 illustrates a detail view of the tank filler neck of FIG. 1.

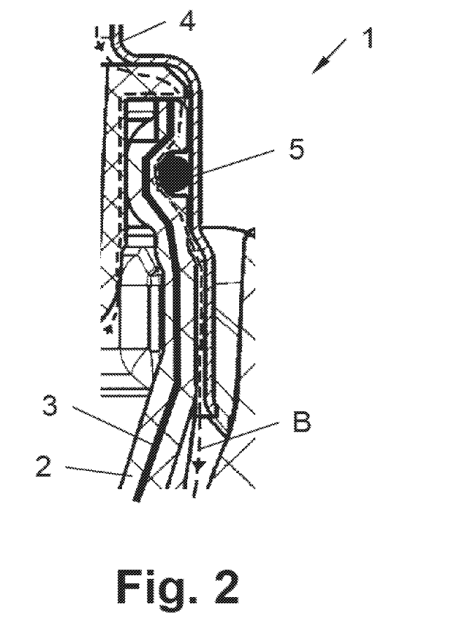

FIG. 3 illustrates a tank filler neck with a seal seated radially on the barrier layer, in accordance with embodiments.

FIG. 4 illustrates a tank filler neck with a seal seated axially on the barrier layer, in accordance with embodiments.

### DESCRIPTION

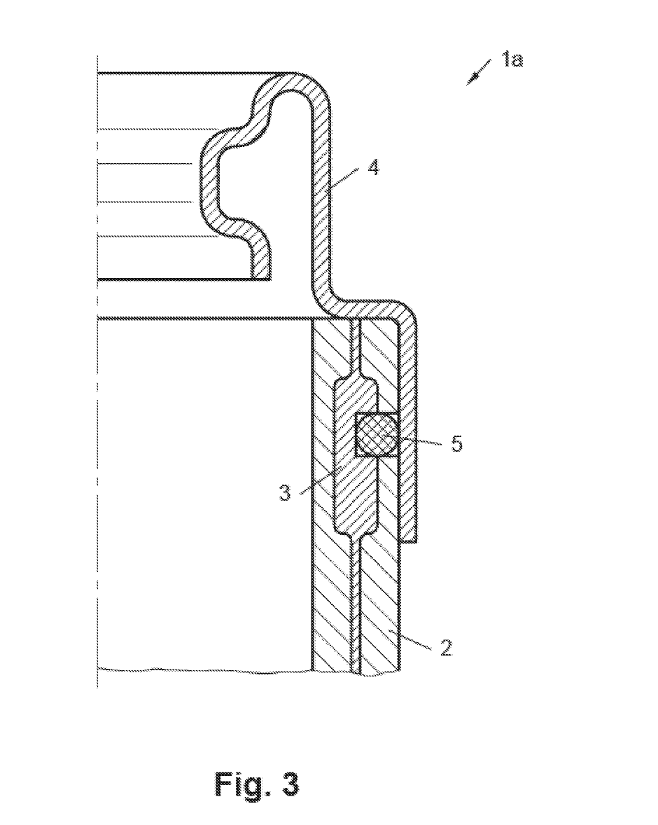

FIG. 3 illustrates a tank filler neck 1a for a motor vehicle, said filler neck comprising a tube 2 composed, for example, of a plastic material. The tube 2 has a tubular barrier layer 3 positioned intermediate to outer and inner layers of the tube 2. The barrier layer 4 is to inhibit diffusion of hydrocarbons more than remaining portion(s) the plastic tube 2. The barrier layer 3 can be composed, for example, of ethylene vinyl alcohol copolymer (EVOH).

A filler head 4 composed, for example, of metal surrounds the tube 2 at an end thereof.

A seal 5 composed, for example, of an elastomeric material is spatially arranged between the plastic tube 2 and the filler head 4. In particular, the seal 5 can be produced from a rubber and/or can be designed as an O-ring. The seal 5 can be, for example, manufactured from acrylonitrile butadiene rubber (NBR), fluororubber (FPM/FKM) or fluorosilicone (FVMQ).

In accordance with embodiments, the seal 5 directly contacts at least a portion of the barrier layer 3. Due to this arrangement, diffusion of hydrocarbons to the outside while bypassing the barrier layer 3 and the seal 5 is prevented. The leaktightness of the system is thereby significantly improved.

As illustrated in FIG. 3, the barrier layer 3 is advantageously embedded into the tube 2. As a result, the barrier layer 3, which is often just a few tenths of a millimeter thick for reasons of cost, is well protected. When seen in cross-section, the barrier layer 3 can therefore be seen as circular, the diameter of which is greater than an inside diameter of the tube 2, and less than an outside diameter of the tube 2.

In accordance with embodiments, the tube 2, for example, can be embodied as a multilayer plastic blowmolding with (in particular) a plurality of layers (such as, e.g., seven layers), in which an impermeable EVOH barrier layer 3, which is bonded to the HDPE layers by adhesion promoters, is situated in the centre between different layers of high-density polyethylene (HDPE). Modified low-density polyethylene (LDPE), for example, can be used as an adhesion promoter.

The barrier layer 3 may not necessarily provide 100% prevention of diffusion. The barrier layer 3, however, is to at least inhibit diffusion, i.e., the permeability of the barrier layer 3 is less than the permeability of the remaining portion(s) the tube 2.

In the example illustrated in FIG. 3, the seal 5 is arranged radially to the outside of the barrier layer 3. To be specific, the seal 5 is arranged in a groove, and the base of the groove is formed by the barrier layer 3. For example, the groove can be produced by milling or sawing. The groove can also be produced directly during the extrusion of the plastic tube 2 for example, e.g., by briefly switching off an external HDPE extruder, which is provided for a layer lying outside the barrier layer 3.

In general, it is advantageous if the barrier layer 3 is made thicker in the region of the seal 5 that contacts the barrier layer 3 than in the remaining portion(s) the plastic tube 2, as illustrated in FIG. 3. In this way, tolerances in respect of the position of the barrier layer 3, the seal 5 and the groove can be compensated more effectively. In particular, this applies to the embodiments in which the groove is produced by machining.

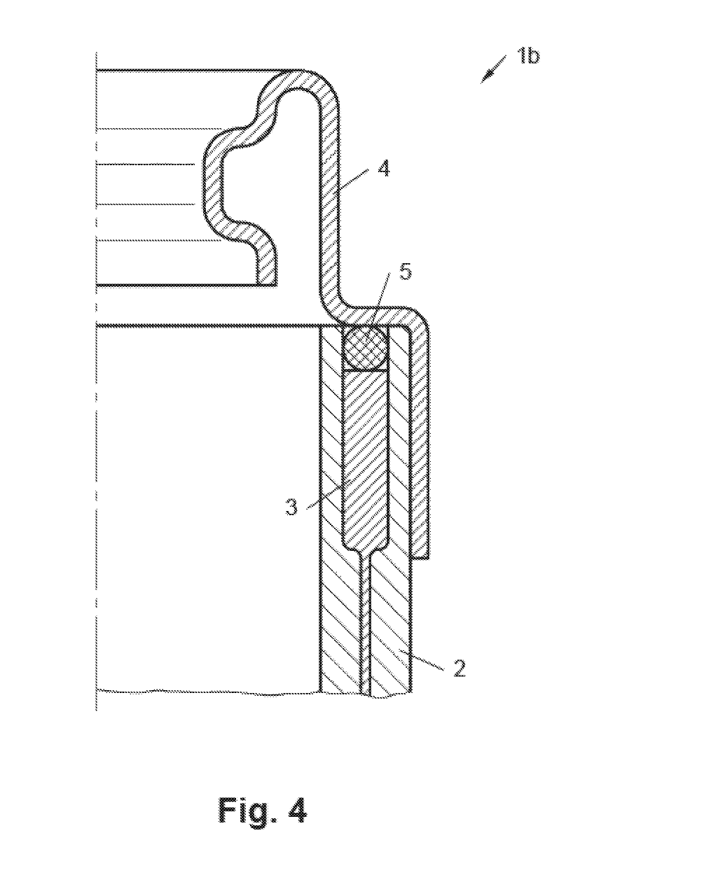

FIG. 4 then illustrates an embodiment of a tank filler neck 1b which is very similar to the tank filler neck 1a illustrated in FIG. 3. In contrast thereto, however, the seal 5 is not arranged radially to the outside of the barrier layer 3 but is arranged axially to the outside of the barrier layer 3. Here too, it is advantageous if the barrier layer 3 is made thicker in the region of the seal 5 that contacts the barrier layer 3 than in the remaining portion(s) the plastic tube 2, as illustrated in FIG. 4. In this way, the tank filler neck 1b remains leaktight even if the seal 5 is not resting exactly centrally on the barrier layer 3. The barrier layer 3, for example, can be exposed by sawing or face milling.

In conclusion, it is noted that the components in the figure may not be illustrated to scale. Position indications such as “right,” “left,” “top,” “bottom” and the like refer to the illustrated position of the respective component and must be notionally revised accordingly when said position changes. It is furthermore noted that the tank filler neck 1a, 1b illustrated can, of course, have more or fewer components than illustrated without thereby departing from the basic concept of embodiments.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

What is claimed is:

1. A tank filler neck for a motor vehicle, comprising:
a tube having a barrier layer which inhibits diffusion of hydrocarbons through the tube at a first region thereof greater than in remaining regions thereof;
a filler head surrounding the tube at an end thereof; and
a seal composed of an elastomer arranged between the plastic tube and the filler head, and which directly contacts the barrier layer.

2. The tank filler neck of claim 1, wherein the seal directly contacts the barrier layer at the first region.

3. The tank filler neck of claim 1, wherein barrier layer has a thickness that is greater in the first region than in remaining portions thereof.

4. The tank filler neck of claim 1, wherein the barrier layer is embedded into the tube.

5. The tank filler neck of claim 1, wherein the barrier layer is composed of ethylene vinyl alcohol copolymer.

6. The tank filler neck of claim 1, wherein the seal is arranged radially to the outside of the barrier layer.

7. The tank filler neck of claim 1, wherein the seal is arranged axially to the outside of the barrier layer.

8. The tank filler neck of claim 1, wherein the barrier layer comprises a groove, and the seal is arranged in the groove.

9. A tank filler neck for a motor vehicle, comprising:
a tube having an outer tube portion and an inner tube portion;
a barrier layer embedded between the outer tube portion and an inner tube portion, the barrier layer having a thickness at a first region thereof that is greater than a thickness than remaining regions thereof; and
a seal arranged to directly contact the barrier layer at the first region.

10. The tank filler neck of claim 9, wherein the barrier layer is composed of ethylene vinyl alcohol copolymer.

11. The tank filler neck of claim 9, wherein the seal is arranged radially to the outside of the barrier layer.

12. The tank filler neck of claim 9, wherein the seal is arranged axially to the outside of the barrier layer.

13. The tank filler neck of claim 9, wherein the barrier layer comprises a groove, and the seal is arranged in the groove.

14. A motor vehicle, comprising:
a tank filler neck including:
a tube having an outer tube portion and an inner tube portion;
a barrier layer embedded between the outer tube portion and an inner tube portion, the barrier layer having a thickness at a first region thereof that is greater than a thickness than remaining regions thereof; and
a seal arranged to directly contact the barrier layer at the first region.

15. The motor vehicle of claim 14, wherein the barrier layer is composed of ethylene vinyl alcohol copolymer.

16. The motor vehicle of claim 14, wherein the seal is arranged radially to the outside of the barrier layer.

17. The motor vehicle of claim 14, wherein the seal is arranged axially to the outside of the barrier layer.

18. The motor vehicle of claim 14, wherein the barrier layer comprises a groove, and the seal is arranged in the groove.
